(19) United States
(12) Patent Application Publication
(10) Pub. No.: US 2026/0369505 A1
(43) Pub. Date: Nov. 19, 2026

(54) MOVABLE CONTACT PART AND BREAKER INCLUDING SAME

(71) Applicant: LS ELECTRIC CO., LTD., Anyang-si, Gyeonggi-do (KR)

(72) Inventors: Seung Pil YANG, Anyang-si, Gyeonggi-do (KR); Woo Jin PARK, Anyang-si, Gyeonggi-do (KR); Kyu Ho LEE, Anyang-si, Gyeonggi-do (KR); Han Baek CHUNG, Anyang-si, Gyeonggi-do (KR)

(21) Appl. No.: 19/137,377

(22) PCT Filed: Dec. 21, 2023
(86) PCT No.: PCT/KR2023/021289

§ 371 Date: Jun. 10, 2025

(30) Foreign Application Priority Data
Jan. 3, 2023 (KR) 10-2023-0000638

(51) Int. Cl. H01H 71/08; H01H 1/22; H01H 1/58; H01H 73/04

(52) U.S. Cl. CPC H01H 71/08; H01H 1/226; H01H 1/5822; H01H 73/04; H01H 2001/228

(57) ABSTRACT

A movable contact part includes a movable terminal conductively connected to an external power source or an external load; a movable cable coupled and electrically connected to the movable terminal and extending to the outside of the movable terminal; and a movable contact bar coupled and electrically connected to the movable cable and configured to be rotatable, in which the movable terminal includes: an insertion space formed through the inside of the movable terminal and configured to accommodate the movable cable; and a buffer space formed through the inside of the movable terminal, configured to communicate with the insertion space, and positioned between the insertion space and one end of the movable terminal based on a longitudinal direction, and in which one end of the movable terminal is pressed toward the insertion space and the buffer space is reduced when an external force is applied to the movable terminal.

### CROSS-REFERENCE TO RELATED APPLICATIONS

This application is a National Stage of International Application No. PCT/KR2023/021289, filed Dec. 21, 2023, which claims priority to and the benefit of Korean Patent Application No. 10-2023-0000638, filed Jan. 3, 2023, the disclosures of which are incorporated herein by reference in its entirety.

### FIELD

The present disclosure relates to a movable contact part and a breaker including the same, and more particularly, to a movable contact part having a structure capable of improving assembling convenience, and a breaker including the same.

### BACKGROUND

A breaker is electrically connected to an external power source and an external load and serves to prevent damage to the power source and the load. The breaker has a plurality of contacts configured to come into contact with each other or separate from each other.

In case that the plurality of contacts is in contact with each other, the external power source and the external load are electrically connected to each other, such that a current may flow. In case that an abnormal current is detected, the plurality of contacts is separated from one another. Therefore, the electrical conduction between the external power source and the external load is blocked, which may prevent damage to the power source and the load caused by the abnormal current.

Some of the plurality of contacts are fixedly installed at particular positions. The contact is referred to as a “fixed contact”. Some of the remaining contacts are configured to be movable in a direction opposite to a direction directed toward the fixed contact. The contact is referred to as a “movable contact”.

The fixed contact and the movable contact are coupled to other components exposed to the outside and conduct electricity. The external power source and the external load may be electrically connected to the fixed contact and the movable contact through the other components.

In this case, the movable contact and the other components are conductively coupled to one another by components, such as cables, made of flexible materials. In this case, this component is pressed and coupled to the other components, but it is difficult to accurately press and couple the components because of the characteristics, i.e., the flexibility of the materials of the components.

Korean Patent No. 10-1754343 discloses a connection terminal unit of a power system control circuit for a substation facility. Specifically, the preceding document discloses the connection terminal unit of the power system control circuit for a substation facility that has a structure capable of coupling a core, a conductive wire, and the like by using first to third connection pressing parts.

However, the connection terminal unit of the power system control circuit for a substation facility disclosed in the preceding document is based on the assumption that the connection terminal unit is provided in the control circuit. That is, the preceding document fails to provide a method of preventing damage to the components and arbitrary separation between the components even in a case in which an abnormal current occurs in case that the connection terminal unit is applied to a configuration that is likely to be damaged when an abnormal current is conducted.

Korean Patent No. 10-0817117 discloses a movable contactor of an air circuit breaker. Specifically, the preceding document discloses the movable contactor of the air circuit breaker having a structure capable of coupling a load side terminal and a lead wire by inserting the lead wire into a space formed in the load side terminal and pressing the lead wire.

However, the preceding document discloses only the structure for coupling the load side terminal and the lead wire. That is, the preceding document fails to disclose a method of preventing the occurrence of a residual space caused by deformation in shape of the lead wire when the lead wire is coupled.
Korean Patent No. 10-1754343 (Jul. 12, 2017)
Korean Patent No. 10-0817117 (Mar. 27, 2008)

### SUMMARY

The present disclosure has been made in an effort to solve the above-mentioned problem, and an object of the present disclosure is to provide a movable contact part having a structure capable of easily coupling a cable to a member electrically connected to the outside, and a breaker including the same.

Another object of the present disclosure is to provide a movable contact part having a structure capable of stably coupling a cable to a member electrically connected to the outside, and a breaker including the same.

Still another object of the present disclosure is to provide a movable contact part having a structure capable of stably maintaining a state in which a cable is coupled to a member electrically connected to the outside, and a breaker including the same.

Yet another object of the present disclosure is to provide a movable contact part capable of applying various modified examples, and a breaker including the same.

Technical problems to be solved by the present disclosure are not limited to the above-mentioned technical problems, and other technical problems, which are not mentioned above, may be clearly understood from the following descriptions by those skilled in the art to which the present disclosure pertains.

One aspect of the present disclosure provides a movable contact part including: a movable terminal conductively connected to an external power source or an external load; a movable cable coupled and electrically connected to the movable terminal and extending to the outside of the movable terminal; and a movable contact bar coupled and electrically connected to the movable cable and configured to be rotatable, in which the movable terminal includes: an insertion space formed through the inside of the movable terminal and configured to accommodate the movable cable; and a buffer space formed through the inside of the movable terminal, configured to communicate with the insertion space, and positioned between the insertion space and one end of the movable terminal based on a longitudinal direction, and in which one end of the movable terminal is pressed toward the insertion space and the buffer space is reduced when an external force is applied to the movable terminal.

In this case, the movable contact part may be provided, in which the movable cable includes a coupling end configured to define one end of the movable cable based on an extension direction and inserted and coupled into the insertion space.

In addition, the movable contact part may be provided, in which a cross-sectional area of the insertion space is equal to or larger than a cross-sectional area of the coupling end.

In this case, the movable contact part may be provided, in which the insertion space extends in the longitudinal direction of the movable terminal, and the buffer space extends in a width direction of the movable terminal.

In addition, the movable contact part may be provided, in which the movable terminal is formed such that an extension length in one direction is longer than an extension length in the other direction, the insertion space is provided as a plurality of insertion spaces disposed to be spaced apart from one another in the other direction, and the buffer space extends in the other direction and communicates with each of the plurality of insertion spaces.

In this case, the movable contact part may be provided, in which the insertion space and the buffer space are positioned to be biased toward one end of the movable terminal based on one direction.

In addition, the movable contact part may be provided, in which the external force is applied to one end of the movable terminal, and the movable terminal and the movable cable are coupled by being pressed.

In this case, the movable contact part may be provided, in which the buffer space is formed to be longer in a width direction of the movable terminal, and the insertion space is formed at a position adjacent to one end of the buffer space and formed to be longer in the longitudinal direction of the movable terminal.

In addition, the movable contact part may include: a movable housing coupled to the movable terminal and the movable contact bar.

In this case, the movable contact part may be provided, in which the movable housing includes: a main housing in which the movable contact bar is movably accommodated; a support plate coupled to the main housing and disposed to partially surround the movable terminal and the movable contact bar; and a rotary housing coupled to the support plate and configured to support the movable contact bar so that the movable contact bar is rotatable.

In addition, the movable contact part may be provided, in which the movable housing includes a rotary shaft penetratively coupled to the movable contact bar and the rotary housing.

In addition, another aspect of the present disclosure may provide a breaker including: a breaker housing in which a housing space is formed; a fixed contact part partially accommodated in the housing space and fixedly coupled to the breaker housing; and a movable contact part partially accommodated in the housing space, positioned adjacent to the fixed contact part, and movably coupled to the breaker housing, in which the fixed contact part includes: a fixed terminal exposed to the outside of the housing space and conductively connected to any one of an external power source and an external load; and a fixed contact accommodated in the housing space and coupled and electrically connected to the fixed terminal, in which the movable contact part includes: a movable terminal exposed to the outside of the housing space and conductively connected to the other of the external power source and the external load; a movable cable accommodated in the housing space and coupled and electrically connected to the movable terminal; and a movable contact bar accommodated in the housing space and coupled and electrically connected to the movable cable, in which the movable terminal includes: an insertion space formed through the inside of the movable terminal and configured to accommodate the movable cable; and a buffer space formed through the inside of the movable terminal and configured to communicate with the insertion space, and in which the movable terminal and the movable cable are pressed and coupled as a cross-sectional area of the insertion space is reduced when an external force is applied to the movable terminal.

In this case, the breaker may be provided, in which the insertion space and the buffer space are positioned to be biased toward one end of the movable terminal accommodated in the housing space among ends of the movable terminal.

In addition, the breaker may be provided, in which a cross-sectional area of the insertion space is equal to or larger than a cross-sectional area of one end of the movable cable accommodated in the insertion space before the external force is applied.

With the above-mentioned configuration, in the movable contact part and the breaker including the same according to the embodiment of the present disclosure, the cable may be easily coupled to the member electrically connected to the outside.

The movable contact part includes the movable terminal conductively coupled to the external power source or the external load. The movable terminal is coupled and electrically connected to the movable contact bar by the movable cable.

The insertion space is formed through the inside of the movable terminal. The coupling end, which defines one end of the movable cable, is accommodated in the insertion space. The insertion space may be formed to have a larger cross-sectional area than the coupling end, and the coupling end may be easily accommodated in the insertion space.

The buffer space is formed through the inside of the movable terminal. The buffer space is formed to communicate with the insertion space.

In the embodiment, the movable terminal and the movable cable may be coupled by being pressed by an applied external force. In this case, a portion deformed in shape of the movable terminal, which is deformed by the external force, is introduced into the buffer space without protruding to the outside of the movable terminal. In addition, the insertion space may be reduced, and the accommodated coupling end may be pressed, such that the movable terminal and the movable cable may be coupled.

Therefore, the movable terminal and the movable cable may be easily coupled.

In addition, with the above-mentioned configuration, in the movable contact part and the breaker including the same according to the embodiment of the present disclosure, the cable may be stably coupled to the member electrically connected to the outside.

In the embodiment, the insertion space and the buffer space may be positioned to be biased toward one end of the movable terminal based on the extension direction. In this case, the insertion space and the buffer space are disposed to be spaced apart from one end of the movable terminal, and the movable terminal is not opened outward in the extension direction thereof. That is, a separate opening portion is not formed at an outer edge of the movable terminal.

Therefore, the deformation in shape of the movable terminal may be minimized in case that an external force is applied to the movable terminal. In addition, the movable cable accommodated in the insertion space is not arbitrarily extracted to the outside of the movable terminal. As a result, the process of coupling the movable terminal and the movable cable may be stably performed.

In addition, with the above-mentioned configuration, in the movable contact part and the breaker including the same according to the embodiment of the present disclosure, the coupled state between the cable and the member electrically connected to the outside may be stably maintained.

As described above, the movable terminal and the movable cable are coupled by being pressed by the external force after the coupling end is accommodated in the insertion space. In this case, a separate opening portion is not formed at the outer edge of the movable terminal. Therefore, before or after the external force is applied, the coupling end accommodated in the insertion space is disposed to be surrounded by the inner periphery of the movable terminal.

In addition, a portion deformed in shape of the movable terminal, which is deformed by the applied external force, is introduced into the buffer space or the insertion space and supports the coupling end of the movable cable.

Therefore, the coupled state between the movable terminal and the movable cable may be stably maintained.

In addition, with the above-mentioned configuration, the movable contact part and the breaker including the same according to the embodiment of the present disclosure may be applied to various modified examples.

The insertion space may be formed in a shape corresponding to the shape of the coupling end of the movable cable. In the embodiment, the movable cable and the insertion space may be formed to have polygonal cross-sections. In addition, in another embodiment, the movable cable and the insertion space may be formed to have circular cross-sections.

In any case, the insertion space may be formed to have a cross-sectional area larger than a cross-sectional area of the movable cable, such that the coupling end may be easily accommodated in the insertion space. In addition, the coupling end accommodated in the insertion space may be pressed and supported by the inner peripheral surface of the movable cable deformed in shape by the applied external force.

Therefore, even in case that the movable cable is deformed in shape, the shape of the insertion space may be deformed in response to the deformation of the movable cable and applied as various shapes.

The effects of the present disclosure are not limited to the above-mentioned effects, and it should be understood that the effects of the present disclosure include all effects that may be derived from the detailed description of the present disclosure or the appended claims.

### BRIEF DESCRIPTION OF THE DRAWINGS

FIG. 1 is a perspective view illustrating a breaker according to an embodiment of the present disclosure.

FIG. 2 is a cross-sectional view taken along line A-A and illustrating the breaker in FIG. 1.

FIG. 3 is an exploded perspective view illustrating components provided in the breaker in

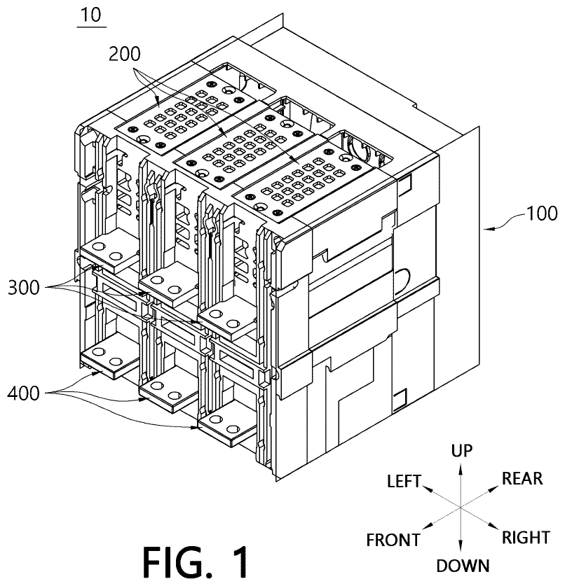

FIG. 1.

FIG. 4 is a perspective view illustrating a movable contact part provided in the breaker in FIG. 1.

FIG. 5 is an exploded perspective view illustrating the movable contact part in FIG. 4.

FIG. 6 is a perspective view illustrating, at another angle, the movable contact part in FIG. 4.

FIG. 7 is an exploded perspective view illustrating the movable contact part in FIG. 4.

FIG. 8 is a front view illustrating a movable terminal provided in the movable contact part in FIG. 4.

FIG. 9 is a use state view illustrating a process of assembling the movable contact part in FIG. 4.

FIGS. 10 and 11 are use state views illustrating a process of assembling a movable contact part according to another embodiment of the present disclosure.

### DETAILED DESCRIPTION

Hereinafter, embodiments of the present disclosure will be described in detail with reference to the accompanying drawings so that those with ordinary skill in the art to which the present disclosure pertains may easily carry out the embodiments. The present disclosure may be implemented in various different ways and is not limited to the embodiments described herein. In the drawings, a part irrelevant to the description will be omitted to clearly describe the present disclosure, and the same or similar constituent elements will be designated by the same reference numerals throughout the specification.

Terms or words used in the specification and the claims should not be interpreted as being limited to a general or dictionary meaning and should be interpreted as a meaning and a concept which conform to the technical spirit of the present disclosure based on a principle that an inventor can appropriately define a concept of a term in order to describe his/her own disclosure by the best method.

Therefore, the embodiments disclosed in the present specification and the configurations illustrated in the drawings are the exemplary embodiments of the present disclosure and do not represent all the technical spirit of the present disclosure. Accordingly, it should be appreciated that various equivalents and modified examples capable of substituting the embodiments may be made at the time of filing the present application.

In the following description, the description of some constituent elements may be omitted in order to clarify the features of the present disclosure.

The term “communication” used in the following description means that one or more members are connected to one another while implementing fluid communication. In the embodiment, the communication may be implemented by members such as conduits, pipes, tubes, and the like. The term “communication” in the following description may be used to mean that one or more members are “fluidly connected” to one another.

The terms “electric conduction” used in the following description means that one or more members are connected to one another so that the members may transmit electric current or electrical signal to one another. In the embodiment, the electric conduction may be implemented in a wired manner by a conductive wire member or the like or implemented in a wireless manner by Bluetooth, Wi-Fi, RFID, or the like. In the embodiment, the electric conduction may include a meaning of “communication”.

The term “fluid” used in the following description refers to any form of material that may flow by an external force and change in shape, volume, or the like. In the embodiment, the fluid may be a liquid such as water or a gas such as air.

In the following description, the terms “upper side,” “lower side,” “left side,” “right side,” “front side,” and “rear side” may be understood with reference to a coordinate system illustrated in FIGS. 1, 2, and 6.

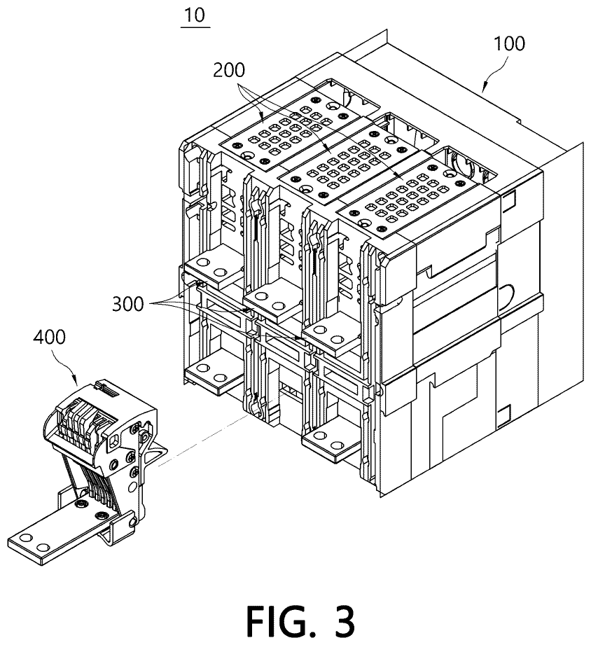

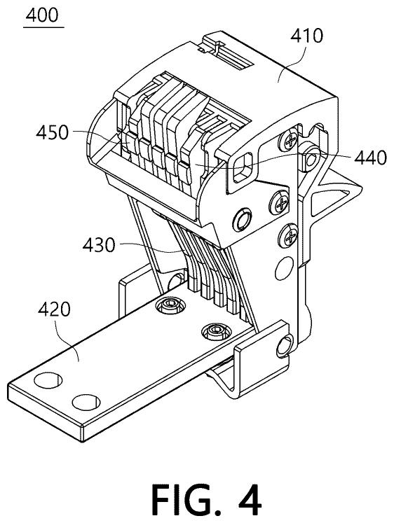

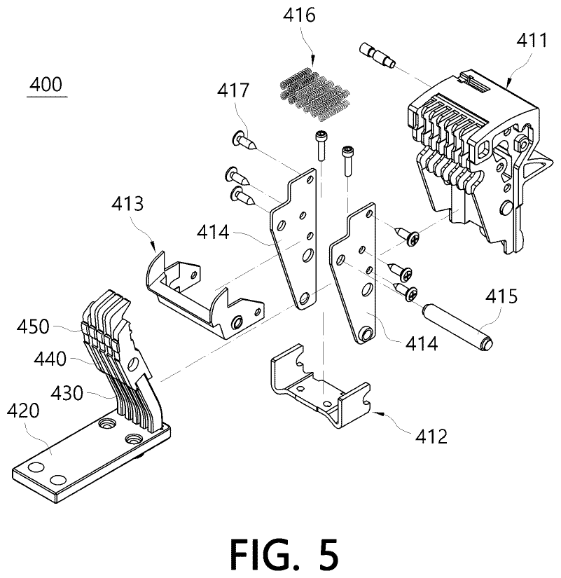

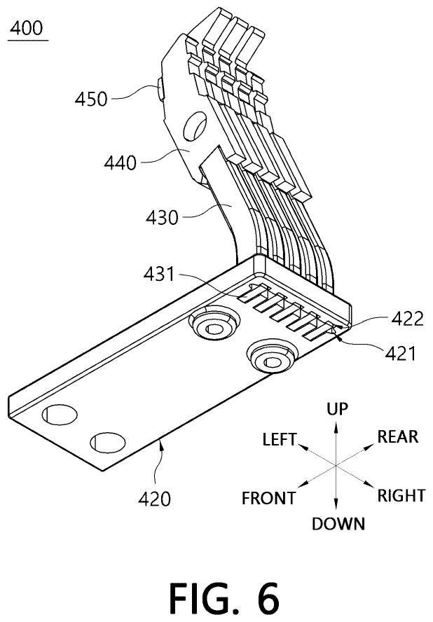

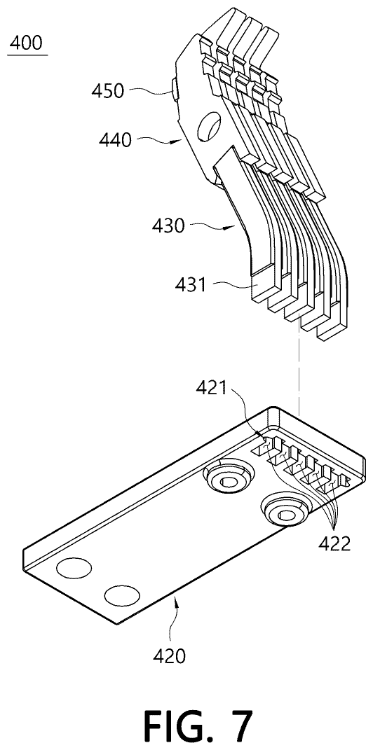

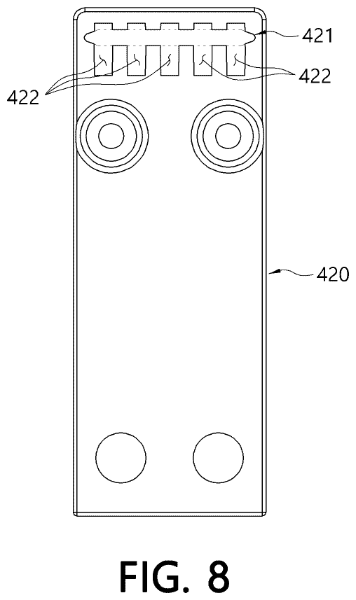

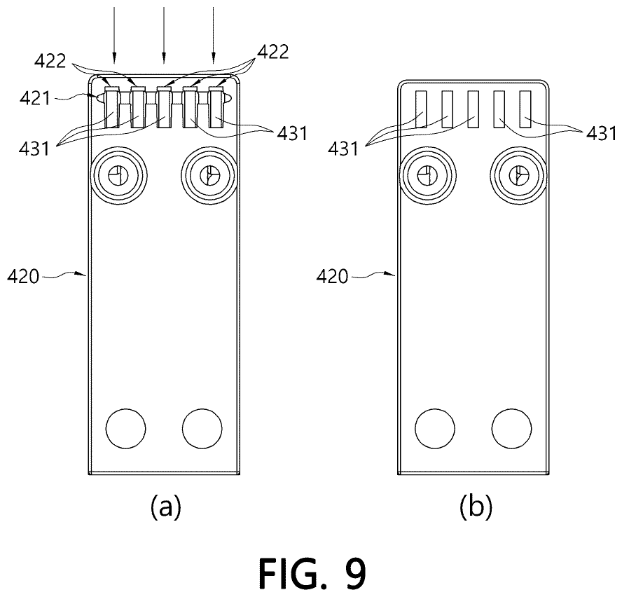

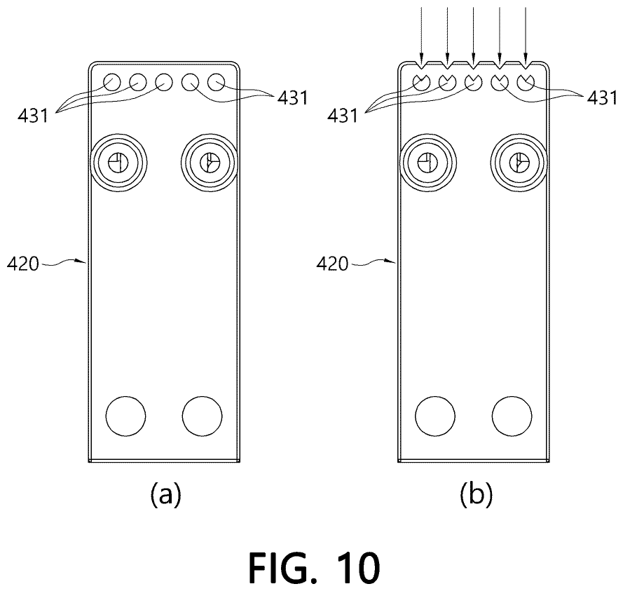

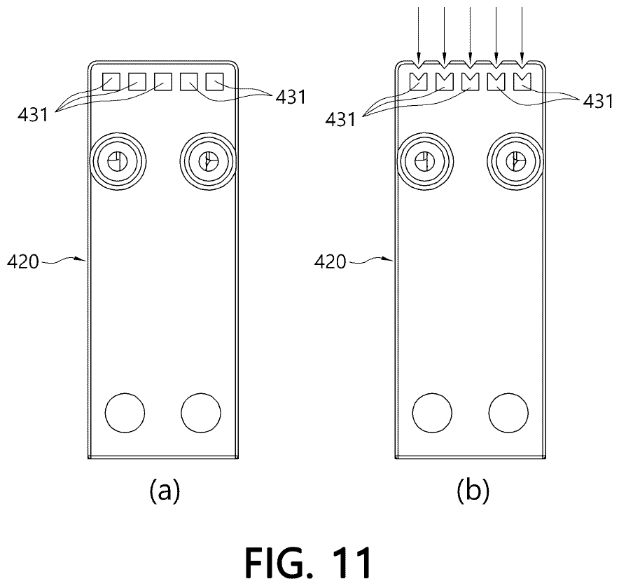

FIGS. 1 to 3 illustrate a breaker 10 according to an embodiment of the present disclosure. The breaker 10 performs electrical conduction with an external power source and an external load. In the embodiment, the breaker 10 may be conductively connected to the external power source and the external load through a conductive wire member (not illustrated) or the like.

In the embodiment, the breaker 10 according to the embodiment of the present disclosure may be provided as an air circuit breaker (ACB). However, the features of the breaker 10 according to the embodiment of the present disclosure to be described below or features of a movable contact part 400 may be applied to various types of breakers such as a vacuum circuit breaker (VCB) or a molded case circuit breaker (MCCB).

Because a process in which the breaker 10 is electrically connected to the external power source and the external load and allows or blocks electrical conduction between the external power source and the external load is a well-known technology, a detailed description thereof will be omitted.

In the illustrated embodiment, the breaker 10 includes a breaker housing 100, an arc extinguishing part 200, a fixed contact part 300, and the movable contact part 400.

The breaker housing 100 defines an external shape of the breaker 10. A space (a housing space 110 to be described below) may be formed in the breaker housing 100 and accommodate the components of the breaker 10.

The breaker housing 100 is conductively connected to the external power source and the external load. This configuration is achieved by the fixed contact part 300 and the movable contact part 400 accommodated in the breaker housing 100.

The breaker housing 100 is coupled to the arc extinguishing part 200. The breaker housing 100 may be coupled to the arc extinguishing part 200 so that the arc extinguishing part 200 communicates with the outside. In the illustrated embodiment, the arc extinguishing part 200 is coupled to an upper portion of a front side of the breaker housing 100.

The breaker housing 100 is coupled to the fixed contact part 300. The breaker housing 100 may accommodate the fixed contact part 300 so that the fixed contact part 300 is partially exposed to the outside. In the illustrated embodiment, the fixed contact part 300 is positioned at the front side of the breaker housing 100 and positioned below the arc extinguishing part 200.

The breaker housing 100 is coupled to the movable contact part 400. The breaker housing 100 may accommodate the movable contact part 400 so that the movable contact part 400 is movable and partially exposed to the outside. In the illustrated embodiment, the movable contact part 400 is positioned at the front side of the breaker housing 100 and positioned below the fixed contact part 300.

The breaker housing 100 may be made of an electrically insulative material. The breaker housing 100 serves to prevent the components accommodated therein from being arbitrarily electrically connected to the external power source or the external load.

The breaker housing 100 may be made of a thermally insulating material. This is to prevent damage caused by heat or pressure occurring in case that an abnormal current is conducted.

In the embodiment, the breaker housing 100 may be made of a synthetic resin material.

The breaker housing 100 may have any shape that may be coupled to the components of the breaker 10 and accommodate the components so that the components are conductively connected to the outside. In the illustrated embodiment, the breaker housing 100 has a polygonal column shape having a quadrangular cross-section in a horizontal direction and a height in an upward/downward direction.

In the illustrated embodiment, the breaker housing 100 includes the housing space 110.

The housing space 110 is a space formed in the breaker housing 100. The housing space 110 accommodates the arc extinguishing part 200, the fixed contact part 300, and the movable contact part 400.

In the illustrated embodiment, the arc extinguishing part 200, the fixed contact part 300, and the movable contact part 400 are positioned at a front side of the housing space 110. In this case, the arc extinguishing part 200, the fixed contact part 300, and the movable contact part 400 are sequentially disposed from above to below.

The housing space 110 is defined by being surrounded by an inner surface of the breaker housing 100. A shape of the housing space 110 may be formed to correspond to a shape of the breaker housing 100. In the illustrated embodiment, the housing space 110 has a polygonal column shape having a quadrangular cross-section and having a height in the upward/downward direction.

The housing space 110 is electrically connected to the external power source and the external load. Specifically, any one of the fixed contact part 300 and the movable contact part 400 accommodated in the housing space 110 is electrically connected to the external power source. In addition, the other of the fixed contact part 300 and the movable contact part 400 accommodated in the housing space 110 is electrically connected to the external load.

The housing space 110 communicates with the outside. Therefore, the arc extinguishing part 200 accommodated in the housing space 110 also communicates with the outside, such that the arc, which occurs when the fixed contact part 300 and the movable contact part 400 are separated, may be discharged to the outside while being extinguished. In the illustrated embodiment, the upper side of the housing space 110 and the arc extinguishing part 200 disposed at the upper side communicate with the outside.

The arc extinguishing part 200 extinguishes the arc occurring when a fixed contact 320 of the fixed contact part 300 and a movable contact 450 of the movable contact part 400 are separated. The generated arc is divided and extinguished while passing through the arc extinguishing part 200 and discharged to the outside. The arc extinguishing part 200 communicates with the housing space 110 and the outside.

The arc extinguishing part 200 is coupled to the breaker housing 100. The arc extinguishing part 200 is accommodated in the housing space 110. In the illustrated embodiment, the arc extinguishing part 200 is positioned to be biased toward the front side of the upper side of the housing space 110.

The arc extinguishing part 200 may be positioned adjacent to the fixed contact 320. Therefore, the arc, which occurs when the fixed contact 320 and the movable contact 450 are separated, may quickly move to the arc extinguishing part 200. In the illustrated embodiment, the arc extinguishing part 200 is positioned above the fixed contact part 300 positioned to be biased toward the front side of the housing space 110.

The arc extinguishing part 200 may extend in a movement direction of a movable contact bar 440. In the illustrated embodiment, the movable contact bar 440 is provided to be movable clockwise or counterclockwise relative to the fixed contact 320. The arc extinguishing part 200 extends in a direction in which the movable contact bar 440 moves away from the fixed contact 320, i.e., extends rearward in the illustrated embodiment.

The arc extinguishing part 200 may be provided as a plurality of arc extinguishing parts 200. The plurality of arc extinguishing parts 200 may be disposed to be spaced apart from one another and positioned adjacent to the plurality of fixed contact parts 300.

In the illustrated embodiment, three arc extinguishing parts 200 are provided and disposed to be spaced apart from one another in a width direction of the breaker housing 100, i.e., a leftward/rightward direction. The number of arc extinguishing parts 200 may vary depending on the number of phases of the current conducted by the breaker 10 or the number of fixed contact parts 300.

The fixed contact part 300 may define one configuration in which the breaker 10 is electrically connected to the external power source or the external load. The fixed contact part 300 is conductively connected to any one of the external power source and the external load.

The fixed contact part 300 is coupled to the breaker housing 100. Some components of the fixed contact part 300 may be accommodated in the housing space 110, and other components of the fixed contact part 300 may be exposed to the outside of the breaker housing 100. The external power source or the external load may be conductively coupled to the other components of the fixed contact part 300.

As can be seen from the designation, the fixed contact part 300 is fixedly coupled to the breaker housing 100. In other words, the fixed contact part 300 is maintained at a position at which the fixed contact part 300 is fixed to the breaker housing 100 or the movable contact part 400 coupled to the breaker housing 100. Therefore, the contact and separation between the fixed contact part 300 and the movable contact part 400 and the electrical conduction and the electric disconnection between the external power source and the external load are achieved by the movement of the movable contact part 400.

The fixed contact part 300 is positioned adjacent to the arc extinguishing part 200 and the movable contact part 400. As the movable contact part 400 moves, the arc extended from the fixed contact part 300 may be quickly moved to the arc extinguishing part 200 and extinguished.

In the illustrated embodiment, the fixed contact part 300 is positioned between the arc extinguishing part 200 and the movable contact part 400. In other words, the fixed contact part 300 is positioned below the arc extinguishing part 200 and positioned above the movable contact part 400.

The fixed contact part 300 may be provided as a plurality of fixed contact parts 400. The plurality of fixed contact parts 300 may be disposed to be spaced apart from one another and positioned between the plurality of arc extinguishing parts 200 and the plurality of movable contact parts 400. In the illustrated embodiment, three fixed contact parts 300 are disposed to be spaced apart from one another in the width direction of the breaker housing 100, i.e., the leftward/rightward direction in the illustrated embodiment.

In the illustrated embodiment, the fixed contact part 300 includes a fixed terminal 310 and the fixed contact 320.

The fixed terminal 310 defines one configuration of the fixed contact part 300. The fixed terminal 310 is partially accommodated in the housing space 110. In other words, a part of the fixed terminal 310 is exposed to the outside of the breaker housing 100, and another part of the fixed terminal 310 is accommodated in the housing space 110. In the illustrated embodiment, a part of a front side of the fixed terminal 310 is exposed to the outside.

The part of the fixed terminal 310, i.e., the part exposed to the outside of the breaker housing 100 is conductively connected to the external power source or the external load. The connection may be implemented by a conductive wire member (not illustrated), a connector member (not illustrated), or the like.

Another part of the fixed terminal 310, i.e., the part accommodated in the housing space 110 is coupled to the fixed contact 320. Another part of the fixed terminal 310 is electrically connected to the fixed contact 320. That is, the fixed terminal 310 is conductively connected to the movable contact part 400 by means of the fixed contact 320.

The fixed terminal 310 may have any shape that may be conductively connected to the external power source, the external load, and the fixed contact 320. In the illustrated embodiment, the fixed terminal 310 has a polygonal plate shape having a quadrangular cross-section and having a thickness in the upward/downward direction.

In this case, the fixed terminal 310 extends in one direction, i.e., a forward/rearward direction in the illustrated embodiment. A front side of the fixed terminal 310 is exposed to the outside of the breaker housing 100, and a rear side of the fixed terminal 310 is accommodated in the housing space 110 and coupled to the fixed contact 320.

The fixed contact 320 is coupled to the fixed terminal 310. The fixed contact 320 is electrically connected to the fixed terminal 310 and the external power source or the external load coupled to the fixed terminal 310.

In addition, the fixed contact 320 comes into contact with or separates from the movable contact 450 in accordance with the movement of the movable contact part 400. The fixed contact 320 is electrically connected, through the movable contact 450, to a movable terminal 420 and the external power source or the external load coupled to the movable terminal 420.

The fixed contact 320 is accommodated in the housing space 110. The fixed contact 320 is coupled to the other portion of the fixed terminal 310, which is accommodated in the housing space 110 among the portions of the fixed terminal 310, i.e., the rear side in the illustrated embodiment.

The fixed contact 320 is positioned adjacent to the arc extinguishing part 200. When an abnormal current occurs, the arc generated from the fixed contact 320 may be moved to the arc extinguishing part 200 and extinguished. In the illustrated embodiment, the fixed contact 320 is positioned below the arc extinguishing part 200.

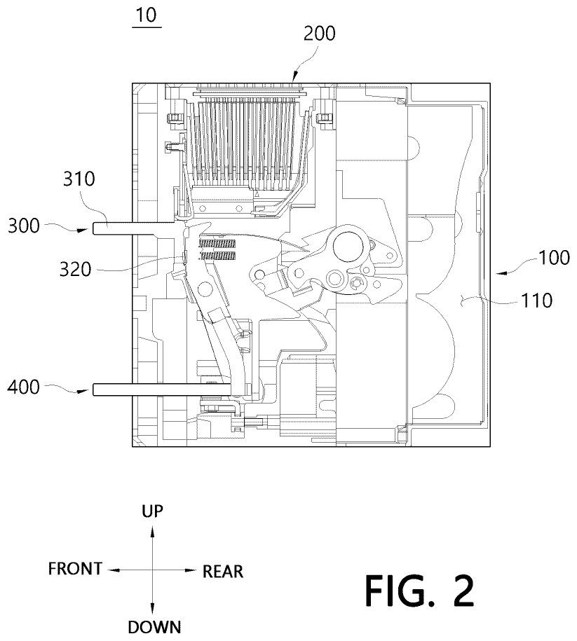

The fixed contact 320 may come into contact with or separate from the movable contact 450 in accordance with the movement of the movable contact part 400. In the embodiment illustrated in FIG. 2, the fixed contact 320 and the movable contact 450 may come into contact with each other when the movable contact 450 moves counterclockwise. In addition, the fixed contact 320 and the movable contact 450 may separate from each other when the movable contact 450 moves clockwise.

The movable contact part 400 may define another configuration in which the breaker 10 is electrically connected to the external power source or the external load. The movable contact part 400 is conductively connected to the other of the external power source and the external load.

The movable contact part 400 is coupled to the breaker housing 100. Some components of the movable contact part 400 may be accommodated in the housing space 110, and other components of the movable contact part 400 may be exposed to the outside of the breaker housing 100. The other of the external power source and the external load may be conductively connected to the other components of the movable contact part 400.

As can be seen from the designation, the movable contact part 400 is movably coupled to the breaker housing 100. In other words, a position of the movable contact part 400 relative to the fixed contact part 300 positioned adjacent to the movable contact part 400 may vary. Therefore, as described above, the contact and separation between the fixed contact part 300 and the movable contact part 400 and the electrical conduction and the electric disconnection between the external power source and the external load are achieved by the movement of the movable contact part 400.

The movable contact part 400 is positioned adjacent to the arc extinguishing part 200 and the fixed contact part 300. In the illustrated embodiment, the movable contact part 400 is positioned below the arc extinguishing part 200 and the fixed contact part 300. In this case, some components of the movable contact part 400 are positioned below the arc extinguishing part 200 and positioned adjacent to the rear side of the fixed contact part 300.

The movable contact part 400 may be provided as a plurality of movable contact parts 400. The plurality of movable contact parts 400 may be disposed to be spaced apart from one another and positioned adjacent to the plurality of arc extinguishing parts 200 and the plurality of fixed contact parts 300. In the illustrated embodiment, three movable contact parts 400 are disposed to be spaced apart from one another in the width direction of the breaker housing 100, i.e., the leftward/rightward direction in the illustrated embodiment.

In the embodiment illustrated in FIGS. 4 to 8, the movable contact part 400 includes a movable housing 410, the movable terminal 420, movable cables 430, the movable contact bars 440, and the movable contacts 450.

The movable housing 410 is coupled to other components of the movable contact part 400. The movable housing 410 supports other components of the movable contact part 400. In the illustrated embodiment, the movable housing 410 supports the movable terminal 420, the movable cable 430, the movable contact bar 440, and the movable contact 450.

The movable housing 410 may fix and support the movable terminal 420. In addition, the movable cable 430, the movable contact bar 440, and the movable contact 450 may be movably supported by the movable housing 410. Therefore, in case that an abnormal current is conducted, the movable terminal 420 is fixed to an original position, and the movable cable 430, the movable contact bar 440, and the movable contact 450 may rotate away from the fixed contact 320.

The movable housing 410 is coupled to the breaker housing 100. In the embodiment, the movable housing 410 is movably coupled to the breaker housing 100. In the embodiment illustrated in FIG. 4, an upper side of a rear side of the movable housing 410 may be rotatably coupled to the breaker housing 100.

In the illustrated embodiment, the movable housing 410 includes a main housing 411, a support housing 412, a rotary housing 413, support plates 414, a rotary shaft 415, elastic members 416, and fastening members 417.

The main housing 411 defines a part of an external shape of the movable housing 410. In the illustrated embodiment, the main housing 411 defines a rear portion of the movable housing 410.

The movable cable 430, the movable contact bar 440, and the movable contact 450 coupled thereto are rotatably supported by the main housing 411. The main housing 411 accommodates the movable cable 430 and the movable contact bar 440.

The main housing 411 may be formed in a shape corresponding to the movable cable 430 and the movable contact bar 440. In the illustrated embodiment, the main housing 411 has a three-dimensional shape having a width in the leftward/rightward direction and a height in the upward/downward direction. In this case, a plurality of small spaces is formed at an upper end of the main housing 411 and opened at front and upper sides thereof. The plurality of movable cables 430 and the movable contact bars 440 are accommodated in the spaces.

The main housing 411 is coupled to the support housing 412 by the support plate 414.

The support housing 412 is coupled to the movable terminal 420 and supports the movable terminal 420. In addition, the support housing 412 is rotatably coupled to the main housing 411.

Therefore, the movable cable 430 and the movable contact bar 440, which are coupled to the main housing 411, and the main housing 411 may rotate relative to the movable terminal 420 and the support housing 412 coupled to the movable terminal 420. In other words, only the movable cable 430 and the movable contact bar 440 may rotate in a state in which the movable terminal 420 is not moved.

The support housing 412 is positioned adjacent to one side directed toward the movable terminal 420, i.e., the lower end in the illustrated embodiment among the sides of the main housing 411.

The support housing 412 is coupled to the support plate 414. In this case, the support housing 412 is rotatably coupled to the support plate 414. Therefore, the support housing 412 is rotatably coupled to the main housing 411 by means of the support plate 414.

The support housing 412 is coupled to the movable terminal 420. The support housing 412 is disposed to surround the movable terminal 420. In the illustrated embodiment, the support housing 412 is disposed to surround a rear portion of the movable terminal 420 from below in the width direction (i.e., left and right sides).

The movable cable 430 and the movable contact bar 440 are rotatably supported by the rotary housing 413. The movable cable 430 and the movable contact bar 440 may be rotatably supported by the rotary housing 413 in the state in which the movable cable 430 and the movable contact bar 440 are accommodated in the main housing 411.

The rotary housing 413 is coupled to the main housing 411. Specifically, the rotary housing 413 is coupled to the support plate 414 fixedly coupled to the main housing 411.

The movable contact bar 440 is rotatably supported by the rotary housing 413. Therefore, the movable cable 430 and the movable contact 450, which are coupled to the movable contact bar 440, may also be rotatably supported by the rotary housing 413.

The rotary housing 413 is disposed to partially surround the movable cable 430 and the movable contact bar 440 accommodated in the main housing 411. In the illustrated embodiment, the rotary housing 413 is disposed to surround front sides of upper sides of the movable cable 430 and the movable contact bar 440. In this case, the movable contact 450 is disposed without being covered by the rotary housing 413, the movable contact 450 may be exposed to the outside of the main housing 411.

The support plate 414 is fixedly coupled to the main housing 411 and partially surrounds the movable cable 430 and the movable contact bar 440 accommodated in the main housing 411. In the illustrated embodiment, the support plate 414 is disposed to surround the movable cable 430 and the movable contact bar 440 in the width direction.

The support plate 414 is rotatably coupled to the support housing 412. The support housing 412 and the movable terminal 420, which is coupled to the support housing 412, are rotatably supported by the support plate 414. The movable terminal 420 is fixedly coupled to the breaker housing 100, such that the support plate 414 may be rotatably coupled to the support housing 412.

In the illustrated embodiment, a protrusion positioned adjacent to a lower end of the support plate 414 protrudes outward. The protrusion may be rotatably inserted and coupled to an opening portion formed at a rear end the support housing 412.

The support plate 414 is coupled to the rotary housing 413. The movable cable 430 and the movable contact bar 440, which are coupled to the rotary housing 413, are rotatably supported by the support plate 414.

In the illustrated embodiment, a through-hole is penetratively formed in a thickness direction (i.e., the leftward/rightward direction) at a position biased toward an upper side of the support plate 414. A through-hole, which is formed through a surface of the rotary housing 413 in the width direction, may be aligned with the through-hole, and the fastening member 417 may be penetratively coupled to the through-hole.

The support plate 414 may be provided as a plurality of support plates 414. The plurality of support plates 414 may be fixedly coupled to the sides of the main housing 411 based on the width direction and coupled to the side of the support housing 412 and the side of the rotary housing 413.

In the illustrated embodiment, the support plates 414 are provided as a pair of support plates 414 coupled to a left edge and a right edge of the main housing 411. In addition, the pair of support plates 414 are respectively coupled to the side of the support housing 412 and the side of the rotary housing 413 based on the width direction.

The movable contact bar 440 is rotatably supported by the rotary shaft 415. The movable cable 430 and the movable contact 450, which are coupled to the movable contact bar 440, and the movable contact bar 440 may rotate about the rotary shaft 415.

The rotary shaft 415 is coupled to the rotary housing 413. Specifically, the rotary shaft 415 is penetratively coupled to the through-hole positioned to be biased toward the front side between the pair of through-holes formed in the surfaces of the rotary housing 413 based on the width direction, i.e., a left surface and a right surface.

The rotary shaft 415 is coupled to the support plate 414. Specifically, the rotary shaft 415 is penetratively coupled to the through-hole adjacent to a front edge of the support plate 414.

The rotary shaft 415 is coupled to the movable contact bar 440. Specifically, the rotary shaft 415 is penetratively coupled to the through-hole penetratively formed in the width direction of the movable contact bar 440.

The rotary shaft 415 may have any shape that may couple the movable contact bar 440 to the rotary housing 413 and the support plate 414 so that the movable contact bar 440 is rotatable. In the illustrated embodiment, the rotary shaft 415 has a cylindrical shape having a circular cross-section and having a length in the leftward/rightward direction.

Because the movable contact bar 440 is rotatably supported by the rotary shaft 415, the movable contact bar 440 and the movable contact 450, which is coupled to the movable contact bar 440, may rotate even though the rotary housing 413 and the main housing 411 do not directly rotate.

The elastic member 416 applies an elastic force to the movable contact bar 440. The movable contact bar 440 is pressed in a direction toward the fixed contact 320 by the elastic force applied by the elastic member 416. Therefore, the movable contact 450 coupled to the movable contact bar 440 is also pressed in the direction toward the fixed contact 320.

Therefore, the reliability of contact between the fixed contact 320 and the movable contact 450 may be ensured in a state in which a normal current is conducted.

The elastic member 416 is accommodated in the main housing 411. Specifically, the elastic member 416 is positioned adjacent to the upper end of the main housing 411 and positioned inward of the movable contact bar 440 accommodated in the main housing 411, and the elastic member 416 is positioned at the rear side in the illustrated embodiment.

The elastic member 416 may have any shape that may apply an elastic force to the movable contact bar 440. In the illustrated embodiment, the elastic member 416 has a coil spring shape having a hollow portion therein and extending in the forward/rearward direction.

In the embodiment, one end of the elastic member 416 based on the extension direction may elastically support the movable contact bar 440, and the other end of the elastic member 416 based on the extension direction may be in contact with the main housing 411.

The elastic members 416 may be provided as a plurality of elastic members 416. The plurality of elastic members 416 may elastically support the plurality of movable contact bars 440. In the illustrated embodiment, five pairs of elastic members 416 are provided, such that a total of ten elastic members 416 are provided. Each pair of the elastic members 416 are disposed to be spaced apart from each other in a height direction of the main housing 411, i.e., the upward/downward direction in the illustrated embodiment.

That is, the pair of elastic members 416 may elastically support one movable contact bar 440.

The fastening member 417 couples the components of the movable housing 410. In the embodiment, the fastening member 417 may fix and couple the components of the movable housing 410. In the illustrated embodiment, the fastening member 417 couples the main housing 411, the rotary housing 413, and the support plate 414.

The fastening member 417 may have any shape that may couple the components of the movable housing 410. In the illustrated embodiment, the fastening member 417 is provided in the form of a screw member.

The fastening members 417 may be provided as a plurality of fastening members 417. The plurality of fastening members 417 may couple the components of the movable housing 410 at different positions. In the illustrated embodiment, three pairs of fastening members 417 are provided.

FIGS. 6 to 8 illustrate the movable terminal 420, the movable cable 430, the movable contact bar 440, and the movable contact 450 provided in the movable contact part 400 according to the embodiment of the present disclosure.

Hereinafter, for convenience of understanding, the terms “upper side,” “lower side,” “left side,” “right side,” “front side,” and “rear side” are defined again and will be described with reference to the coordinate system illustrated in FIG. 6.

The movable terminal 420 defines one configuration of the movable contact part 400. The movable terminal 420 is partially accommodated in the housing space 110. In other words, a part of the movable terminal 420 is exposed to the outside of the breaker housing 100, and another part of the movable terminal 420 is accommodated in the housing space 110. In the illustrated embodiment, a part of a front side of the movable terminal 420 is exposed to the outside.

The part of the movable terminal 420, i.e., the part exposed to the outside of the breaker housing 100 is conductively connected to the external power source or the external load. The connection may be implemented by a conductive wire member (not illustrated), a connector member (not illustrated), or the like.

Another part of the movable terminal 420, i.e., the part accommodated in the housing space 110 is coupled to the movable cable 430. Another part of the movable terminal 420 is electrically connected to the movable cable 430. That is, the movable terminal 420 is conductively connected to the movable contact bar 440 and the movable contact 450 by means of the movable cable 430.

The movable terminal 420 may have any shape that may be conductively connected to the external power source, the external load, and the movable cable 430. In the illustrated embodiment, the movable terminal 420 has a polygonal plate shape having a quadrangular cross-section and having a thickness in the upward/downward direction.

The movable terminal 420 extends in one direction, i.e., the forward/rearward direction in the illustrated embodiment. A front side of the movable terminal 420 is exposed to the outside of the breaker housing 100, and a rear side of the movable terminal 420 is accommodated in the housing space 110 and coupled to the movable cable 430.

The movable terminal 420 may have any shape and be coupled to the movable cable 430. In the embodiment, after the movable cable 430 is inserted into the space formed in the movable terminal 420, the movable terminal 420 and the movable cable 430 may be coupled by being pressed by an external force applied to the movable terminal 420.

In this case, the movable terminal 420 according to the embodiment of the present disclosure may be easily coupled to the movable cable 430. In addition, the movable terminal 420 and the movable cable 430 may be completely coupled even without a separate subsequent process. Furthermore, a coupled state between the movable terminal 420 and the movable cable 430 may be stably maintained.

To this end, in the illustrated embodiment, the movable terminal 420 includes buffer spaces 421 and insertion spaces 422.

The buffer space 421 compensates for a portion deformed in shape of the movable terminal 420 occurring during the press-forming process. That is, the buffer space 421 accommodates a part of the movable terminal 420 deformed by the press-forming process. Therefore, even in case that the movable terminal 420 is subjected to the press-forming process, the movable terminal 420 may not inadvertently protrude outward, or the movable terminal 420 may not be excessively tightly attached to the movable cable 430.

The buffer space 421 is formed through the inside of the movable terminal 420. In the illustrated embodiment, the buffer space 421 is positioned to be biased toward a rear end of the movable terminal 420 and positioned to be spaced apart from the rear end of the movable terminal 420.

The buffer space 421 may be formed in any shape that may prevent arbitrary deformation in shape of the movable terminal 420 by accommodating the portion deformed in shape of the movable terminal 420. In the illustrated embodiment, the buffer space 421 extends in the width direction of the movable terminal 420, i.e., the leftward/rightward direction and is penetratively formed in the thickness direction of the movable terminal 420, i.e., the upward/downward direction.

In this case, the end of the buffer space 421 based on the extension direction may be disposed to be spaced apart from the edges of the movable terminal 420 based on the width direction, i.e., the left edge and the right edge. That is, the front side, the rear side, the left side, and the right side of the buffer space 421 are surrounded by an inner periphery of the movable terminal 420.

The buffer spaces 421 respectively communicate with the plurality of insertion spaces 422.

The insertion space 422 accommodates a coupling end 431 of the movable cable 430. In this case, the insertion space 422 may be formed to have a larger cross-sectional area than the coupling end 431. Therefore, the coupling end 431 may be easily accommodated in the insertion space 422 before the press-forming process.

The insertion space 422 is formed through the inside of the movable terminal 420. In the illustrated embodiment, the insertion space 422 is positioned to be biased toward the rear end of the movable terminal 420 and positioned to be spaced apart from the rear end of the movable terminal 420.

The insertion space 422 may be formed in a shape corresponding to a shape of a cross-section of the coupling end 431. In the embodiment illustrated in FIGS. 6 to 9, the insertion space 422 is formed as a space having a polygonal column shape penetratively formed in the upward/downward direction and having a width in the leftward/rightward direction and a height in the forward/rearward direction.

The insertion space 422 communicates with the buffer space 421. In other words, the insertion space 422 may be disposed to at least partially overlap the buffer space 421. The portion deformed in shape of the movable terminal 420, which occurs when one surface of the movable terminal 420 (i.e., an inner surface of a rear side in the illustrated embodiment) surrounding the insertion space 422 is pressed as the press-forming process is performed, may be introduced into the buffer space 421.

Therefore, the deformation in shape of the movable terminal 420 may be minimized even in case that the movable terminal 420 and the movable cable 430 are coupled by the press-forming process. Therefore, the movable terminal 420 and the movable terminal 420 may be easily coupled, and a separate subsequent process is not required.

The insertion spaces 422 may be provided as a plurality of insertion spaces 422. The plurality of insertion spaces 422 may be disposed to be spaced apart from one another in the direction in which the buffer space 421 extends, i.e., the leftward/rightward direction in the illustrated embodiment. In this case, the plurality of insertion spaces 422 may respectively communicate with the buffer spaces 421.

In the illustrated embodiment, five insertion spaces 422 are formed and accommodate the coupling ends 431 of the five movable cables 430. The number of insertion spaces 422 and the method of disposing the insertion spaces 422 may vary depending on the number of coupling ends 431 and the method of disposing the coupling ends 431.

The movable cable 430 conductively connects the movable terminal 420 and the movable contact bar 440. The movable cable 430 is coupled to the movable terminal 420 and the movable contact bar 440.

The movable cable 430 may be made of a flexible material. In addition, the movable cable 430 may be made of an electrically conductive material. In the embodiment, the movable cable 430 may be made of copper (Cu) or an alloy material containing copper (Cu).

The movable cable 430 may extend between the movable terminal 420 and the movable contact bar 440. In the illustrated embodiment, the movable cable 430 extends in the upward/downward direction. One end of the movable cable 430 based on the extension direction, i.e., the lower end in the illustrated embodiment is coupled to the movable terminal 420. The other end of the movable cable 430 based on the extension direction, i.e., the upper end in the illustrated embodiment is coupled to the movable contact bar 440.

The movable cables 430 may be provided as a plurality of movable cables 430. The plurality of movable cables 430 may be disposed to be spaced apart from one another and coupled to the movable terminal 420 and the plurality of movable contact bars 440.

In the illustrated embodiment, five movable cables 430 may be provided and coupled and electrically connected to the movable terminal 420 and the five movable contact bars 440.

One end of the movable cable 430 based on the extension direction, i.e., one end coupled to the movable terminal 420 is defined as the coupling end 431.

The coupling end 431 is a portion where the movable cable 430 is coupled to the movable terminal 420. The coupling end 431 is inserted and coupled into the insertion space 422 of the movable terminal 420. As described above, the coupling end 431 may be formed to have a cross-section smaller than a cross-section of the insertion space 422. Therefore, the coupling end 431 may be easily accommodated in the insertion space 422.

A process of coupling the movable terminal 420 and the movable cable 430 will be described below in detail.

The movable contact bar 440 is electrically connected to the movable terminal 420 through the movable cable 430. The movable contact bar 440 is coupled to the movable cable 430. The movable contact bar 440 is coupled and electrically connected to the movable contact 450. Therefore, the movable terminal 420 and the movable contact 450 may be electrically connected.

The movable contact bar 440 is coupled to the other end of the movable cable 430 based on the extension direction, i.e., the upper end in the illustrated embodiment. The movable contact bar 440 is disposed to cover an upper portion of the movable cable 430 from the outside.

The movable contact bar 440 may have any shape that may be coupled to the movable cable 430 and form the movable contact 450. In the illustrated embodiment, the movable contact bar 440 extends in the upward/downward direction.

The movable contact bar 440 is rotatably coupled to the rotary housing 413. A through-hole may be formed in a middle portion of the movable contact bar 440 based on the extension direction, and the rotary shaft 415 may be penetratively coupled to the through-hole. The movable contact bar 440 may be rotatably supported on the rotary housing 413 by the rotary shaft 415. Therefore, the movable contact 450 may come into contact with or separate from the fixed contact 320.

The movable contact bars 440 may be provided as a plurality of movable contact bars 440. The plurality of movable contacts bars 440 may be disposed to be spaced apart from one another and respectively coupled to the plurality of movable cables 430 and the plurality of movable contacts 450.

In the illustrated embodiment, five movable contact bars 440 are provided and respectively coupled to the five movable cables 430 and the five movable contact bars 440.

The movable contact 450 is coupled to the movable contact bar 440. The movable contact 450 is electrically connected to the external power source or the external load through the movable cable 430 and the movable terminal 420 coupled and electrically connected to the movable contact bar 440.

In addition, the movable contact 450 comes into contact with or separates from the fixed contact 320 in accordance with the rotation of the movable contact bar 440. The movable contact 450 is electrically connected, through the fixed contact 320, to the fixed terminal 310 and the external power source or the external load coupled to the fixed terminal 310.

The movable contact 450 is positioned adjacent to the arc extinguishing part 200. When an abnormal current occurs, the arc generated between the fixed contact 320 and the movable contact 450 is extended along the movable contact 450 that moves, and the arc may be moved to the arc extinguishing part 200 and extinguished. In the illustrated embodiment, the movable contact 450 is positioned below the arc extinguishing part 200 and positioned rearward of the fixed contact 320.

FIG. 9 illustrates a process in which the movable terminal 420 and the movable cable 430 of the movable contact part 400 according to the embodiment of the present disclosure are coupled.

With reference to FIG. 9A, the coupling end 431 of the movable cable 430 is accommodated in the insertion space 422. In the embodiment in which the plurality of movable cables 430 and the plurality of insertion spaces 422 are provided, the plurality of coupling ends 431 are respectively accommodated in the plurality of insertion spaces 422.

In this case, the insertion space 422 is formed to have a larger cross-sectional area than the coupling end 431. In the illustrated embodiment, lengths of the insertion space 422 in the width direction and the height direction are larger than a width and a height of the coupling end 431. Therefore, the coupling end 431 may be easily accommodated in the insertion space 422.

When an external force is applied to the lower side of the movable terminal 420 in the state in which the coupling end 431 is accommodated in the insertion space 422, the movable terminal 420 is deformed in shape, and the movable terminal 420 and the movable cable 430 are coupled. Therefore, the buffer space 421 and the insertion space 422 may be reduced, such that the movable cable 430 may be coupled to the movable terminal 420.

Although not illustrated, the sides of the movable terminal 420 based on the width direction, i.e., the left and right sides may be supported by a mold or the like. Therefore, the deformation in shape of the movable terminal 420 may be restricted forward in the width direction or inward in the width direction, instead of outward in the width direction, by the external force applied to the rear side of the movable terminal 420.

FIG. 9B illustrates a state in which the movable terminal 420 is deformed in shape by the applied external force, and the coupling end 431 accommodated in the insertion space 422 is pressed.

As described above, the movable terminal 420 may be supported the width direction by the mold. Therefore, the upper portion of the movable terminal 420 may be deformed in shape forward and inward the width direction by the external force applied to the rear side of the movable terminal 420 and pressed and coupled to the coupling end 431 accommodated in the insertion space 422.

Therefore, the movable terminal 420 and the movable cable 430 may be easily coupled only by applying an external force. In addition, the movable terminal 420 and the movable cable 430 may be pressed and coupled even without a separate subsequent process, and the coupled state may be stably maintained. Furthermore, it is possible to prevent inadvertent deformation in shape of the movable terminal 420.

FIGS. 10 and 11 illustrate a process in which the movable terminal 420 and the movable cable 430 of the movable contact part 400 according to another embodiment of the present disclosure are coupled.

In the embodiment illustrated in FIG. 10, the insertion space 422 and the coupling end 431 are formed to have circular cross-sections. In addition, in the embodiment illustrated in FIG. 11, the insertion space 422 and the coupling end 431 are formed to have quadrangular cross-sections.

In the illustrated embodiment, the insertion space 422 is formed to have the same shape as the coupling end 431. That is, in the embodiment illustrated in FIG. 10, the insertion space 422 is formed to have a circular cross-section corresponding to a shape of the coupling end 431. In addition, in the embodiment illustrated in FIG. 11, the insertion space 422 is formed to have a quadrangular cross-section corresponding to a shape of the coupling end 431.

That is, in the illustrated embodiment, the insertion space 422 is provided in the movable terminal 420, but the buffer space 421 is not formed separately. Therefore, when an external force is applied to the movable terminal 420, the movable terminal 420 may be coupled to the movable cable 430 while partially deforming the shape of the coupling end 431.

Alternatively, the above-mentioned buffer space 421 may be provided, such that the movable terminal 420 and the movable cable 430 may be coupled without deforming the shape of the coupling end 431.

That is, the movable terminal 420 according to the embodiment of the present disclosure may be easily and reliably coupled to the movable cable 430 even though the end based on the extension direction, i.e., the upper end is not opened. In addition, inadvertent deformation in shape of the movable terminal 420 may be prevented, such that a subsequent process is not required, which may simplify the manufacturing process.

In this case, the external force applied to the lower end of the movable terminal 420 may be applied to a position corresponding to the position of the coupling end 431. That is, as illustrated in FIGS. 10B and 10B, the external force may be applied to five points positioned perpendicularly below the coupling end 431.

The lower end of the movable terminal 420 is deformed in shape forward by the applied external force, such that the plurality of coupling ends 431 may be deformed in shape forward and coupled to the movable terminal 420.

While the embodiments of the present disclosure have been described, the spirit of the present disclosure is not limited to the embodiments presented in the present specification, those skilled in the art, who understand the spirit of the present disclosure, may easily propose other embodiments by adding, changing, deleting constituent elements within the same spirit and scope of the present disclosure, and it can be said that the embodiments are also within the spirit and scope of the present disclosure.

| | |
|---|---|
| 10: Breaker | 100: Breaker Housing |
| 110: Housing Space | 200: Arc Extinguishing Part |
| 300: Fixed Contact Part | 310: Fixed Terminal |
| 320: Fixed Contact | 400: Movable Contact Part |
| 410: Movable Housing | 411: Main Housing |
| 412: Support Housing | 413: Rotary Housing |
| 414: Support Plate | 415: Rotary Shaft |
| 416: Elastic Member | 417: Fastening Member |
| 420: Movable Terminal | 421: Buffer Space |
| 422: Insertion Space | 430: Movable Cable |
| 431: Coupling End | 440: Movable Contact Bar |
| 450: Movable Contact | |

What is claimed is:

1. A movable contact part comprising:
a movable terminal conductively connected to an external power source or an external load;
a movable cable coupled and electrically connected to the movable terminal and extending to the outside of the movable terminal; and
a movable contact bar coupled and electrically connected to the movable cable and configured to be rotatable,
wherein the movable terminal comprises:
an insertion space formed through the inside of the movable terminal and configured to accommodate the movable cable; and
a buffer space formed through the inside of the movable terminal, configured to communicate with the insertion space, and positioned between the insertion space and one end of the movable terminal based on a longitudinal direction, and
wherein one end of the movable terminal is pressed toward the insertion space and the buffer space is reduced when an external force is applied to the movable terminal.

2. The movable contact part of claim 1, wherein the movable cable comprises a coupling end configured to define one end of the movable cable based on an extension direction and inserted and coupled into the insertion space.

3. The movable contact part of claim 2, wherein a cross-sectional area of the insertion space is equal to or larger than a cross-sectional area of the coupling end.

4. The movable contact part of claim 1, wherein the insertion space extends in the longitudinal direction of the movable terminal, and the buffer space extends in a width direction of the movable terminal.

5. The movable contact part of claim 1, wherein the movable terminal is formed such that an extension length in one direction is longer than an extension length in the other direction,
wherein the insertion space is provided as a plurality of insertion spaces disposed to be spaced apart from one another in the other direction, and
wherein the buffer space extends in the other direction and communicates with each of the plurality of insertion spaces.

6. The movable contact part of claim 5, wherein the insertion space and the buffer space are positioned to be biased toward one end of the movable terminal based on one direction.

7. The movable contact part of claim 6, wherein the external force is applied to one end of the movable terminal, and the movable terminal and the movable cable are coupled by being pressed.

8. The movable contact part of claim 1, wherein the buffer space is formed to be longer in a width direction of the movable terminal, and
wherein the insertion space is formed at a position adjacent to one end of the buffer space and formed to be longer in the longitudinal direction of the movable terminal.

9. The movable contact part of claim 1, comprising:
a movable housing coupled to the movable terminal and the movable contact bar.

10. The movable contact part of claim 9, wherein the movable housing comprises:
a main housing in which the movable contact bar is movably accommodated;
a support plate coupled to the main housing and disposed to partially surround the movable terminal and the movable contact bar; and
a rotary housing coupled to the support plate and configured to support the movable contact bar so that the movable contact bar is rotatable.

11. The movable contact part of claim 10, wherein the movable housing comprises a rotary shaft penetratively coupled to the movable contact bar and the rotary housing.

12. A breaker comprising:
a breaker housing in which a housing space is formed;
a fixed contact part partially accommodated in the housing space and fixedly coupled to the breaker housing; and
a movable contact part partially accommodated in the housing space, positioned adjacent to the fixed contact part, and movably coupled to the breaker housing,
wherein the fixed contact part comprises:
a fixed terminal exposed to the outside of the housing space and conductively connected to any one of an external power source and an external load; and
a fixed contact accommodated in the housing space and coupled and electrically connected to the fixed terminal,
wherein the movable contact part comprises:
a movable terminal exposed to the outside of the housing space and conductively connected to the other of the external power source and the external load;
a movable cable accommodated in the housing space and coupled and electrically connected to the movable terminal; and
a movable contact bar accommodated in the housing space and coupled and electrically connected to the movable cable,
wherein the movable terminal comprises:
an insertion space formed through the inside of the movable terminal and configured to accommodate the movable cable; and
a buffer space formed through the inside of the movable terminal and configured to communicate with the insertion space, and
wherein the movable terminal and the movable cable are pressed and coupled as a cross-sectional area of the insertion space is reduced when an external force is applied to the movable terminal.

13. The breaker of claim 12, wherein the insertion space and the buffer space are positioned to be biased toward one end of the movable terminal accommodated in the housing space among ends of the movable terminal.

14. The breaker of claim 12, wherein a cross-sectional area of the insertion space is equal to or larger than a cross-sectional area of one end of the movable cable accommodated in the insertion space before the external force is applied.
